(19) United States
(12) Patent Application Publication
(10) Pub. No.: US 2025/0043772 A1
(43) Pub. Date: Feb. 6, 2025

(54) LIGHTNING PROTECTION SYSTEM

(71) Applicant: Vestas Wind Systems A/S, Aarhus N (DK)

(72) Inventors: Nathan A. Brilliant, Arvada, CO (US); Toby Collard, Cowes, Isle of Wight (GB); Edward Noel Finn, Isle of Wight (GB)

(73) Assignee: Vestas Wind Systems A/S, Aarhus N (DK)

(21) Appl. No.: 18/717,524

(22) PCT Filed: Dec. 8, 2022
(86) PCT No.: PCT/DK2022/050272

§ 371 Date: Jun. 7, 2024

Related U.S. Application Data
(60) Provisional application No. 63/288,103, filed on Dec. 10, 2021.

(30) Foreign Application Priority Data
Jan. 11, 2022 (DK) PA 202270012

(51) Int. Cl. F03D 80/30; F03D 1/06

(52) U.S. Cl. CPC F03D 80/30; F03D 1/0675; F05B 2230/30

(57) ABSTRACT

A wind turbine blade having a blade shell with a lightning protection system; the lightning protection system comprising: a first electrically conductive pin, and a second electrically conductive pin adjacent to the first electrically conductive pin; a metal layer at an outer surface of the blade shell, the metal layer split into a first portion and a second portion with a discontinuity between the first and second portions; wherein the first electrically conductive pin extends through the first portion of the metal layer and not through the second portion of the metal layer; and wherein the second electrically conductive pin extends through the second portion of the metal layer and not through the first portion of the metal layer.

### FIELD OF THE INVENTION

The present invention relates to relates to a wind turbine blade having a blade shell with a lightning protection system, and a method of manufacturing a wind turbine blade having a blade shell.

### BACKGROUND OF THE INVENTION

Wind turbines are susceptible to lightning strikes, and the blades of wind turbines are particularly susceptible to lightning strikes.

As a result, it is common for a wind turbine blade to include a lighting protection system that electrically couples the wind turbine blade to ground. This lightning protection system may include lightning receptors and conductors that are electrically connected from the blade, through the tower and nacelle, to ground. The lightning protection system may also include a surface protection layer (SPL), for instance a metal mesh or foil surface protection layer, incorporated into the blade shell at the outer surface of the blade and extending along at least a portion of the blade. This surface protection layer typically covers a significant portion of the blade surface and intercepts lightning strikes before reaching conductive components of the blade. The surface protection layer is typically connected to the lightning protection system at numerous points so as to ensure a good electrical connection from the surface protection layer.

### SUMMARY OF THE INVENTION

A first aspect of the invention provides a wind turbine blade having a blade shell with a lightning protection system; the lightning protection system comprising: a first electrically conductive pin, and a second electrically conductive pin adjacent to the first electrically conductive pin; a metal layer at an outer surface of the blade shell, the metal layer split into a first portion and a second portion with a discontinuity between the first and second portions; wherein the first electrically conductive pin extends through the first portion of the metal layer and not through the second portion of the metal layer; and wherein the second electrically conductive pin extends through the second portion of the metal layer and not through the first portion of the metal layer.

A second aspect of the invention provides a method of manufacturing a wind turbine blade having a blade shell, comprising: providing a blade mould, and a metal layer of a lightning protection system of the blade shell, wherein the metal layer is split into a first portion and a second portion; determining a respective blade position of a first electrically conductive pin and a second electrically conductive pin; laying a first portion of the metal layer in the blade mould so as to overlay the determined blade position of the first electrically conductive pin and not overlay the determined blade position of the second electrically conductive pin; laying a second portion of the metal layer in the blade mould so as to overlay the determined blade position of the second electrically conductive pin and not overlay the determined blade position of the first electrically conductive pin.

With this arrangement, the degree of warping and/or shear of the metal layer may be decreased, as the handleability of multiple, smaller, discrete metal layer portions is greater than a single, integral, metal layer portion including multiple electrically conductive pin locations that each have a determined blade position. This advantage is further highlighted when considering the ability of the metal layer to conform to the three-dimensional shape of the blade, as the drapeability of the metal layer may be significantly complicated when there are two determined blade positions for corresponding electrically conductive pins within a single portion of the metal layer. Having multiple portions of the metal layer may also reduce the effect of any processing or manufacturing errors, and accommodate variations in the metal layer among a plurality of blade shapes within a family of blades, as only a portion of the metal layer may be affected.

The first portion and the second portion may partially overlap to form an overlap region.

The wind turbine blade may comprise an electrical component, wherein the first portion of the metal layer is electrically connected to the electrical component by the first electrically conductive pin and the second portion of the metal layer is electrically connected to the electrical component by the second electrically conductive pin.

The electrical component may be a down conductor of the lightning protection system.

The first electrically conductive pin may extend through a first unitary disc formed across the metal layer and/or the second electrically conductive pin may extend through a second unitary disc formed across the metal layer.

The metal layer may be a first metal layer, and the lightning protection system may further comprise a second metal layer at the outer surface of the blade shell. The second metal layer may be split into a first portion and a second portion with a discontinuity between the first and second portions, wherein the first portion of the second metal layer is stacked on the first portion of the first metal layer to form intimate electrical contact with the first portion of the first metal layer, and wherein the first electrically conductive pin extends through the first portion of the first metal layer and the first portion of the second metal layer; and/or wherein the second portion of the second metal layer is stacked on the second portion of the first metal layer to form intimate electrical contact with the second portion of the first metal layer, and wherein the second electrically conductive pin extends through the second portion of the first metal layer and the second portion of the second metal layer.

The first unitary disc may extend through the first portion of the first metal layer and the first portion of the second metal layer and/or the second unitary disc may extend through the second portion of the first metal layer and the second portion of the second metal layer.

The first portion and the second portion of the first and/or second metal layer may be formed of the same material. The first portion and the second portion of the first and/or second metal layer may have the same thickness.

The first metal layer and the second metal layer may be formed of different materials. The first portion of the first metal layer may be formed of a different material to the second portion of the first metal layer. The first portion of the second metal layer may be formed of a different material to the second portion of the second metal layer. The different materials may be aluminium and copper.

The step of laying a first portion of the metal layer in the blade mould may further comprise aligning a pin locating feature of the first portion of the metal layer with the determined blade position of the first electrically conductive pin; and/or the step of laying a second portion of the metal layer in the blade mould may further comprise aligning a pin locating feature of the second portion of the metal layer with the determined blade position of the second electrically conductive pin.

The step of laying a second portion of the metal layer in the blade mould may further comprise overlapping an edge of the second portion with an edge of the first portion to form an overlap region.

The method of manufacturing a wind turbine blade may further comprise extending a first electrically conductive pin through the first portion of the metal layer and coupling the first electrically conductive pin to a down conductor; and/or extending a second electrically conductive pin through the second portion of the metal layer and coupling the second electrically conductive pin to a down conductor.

The method of manufacturing a wind turbine blade may further comprise laying fibre layers of the blade shell in the blade mould; and consolidating the fibre layers and the metal layer in the blade mould and integrating the fibre layers and metal layer with a resin.

The method of manufacturing a wind turbine blade may further comprise, prior to laying the metal layer in the blade mould: providing one or more first metal disc constituents; and heating the one or more first metal disc constituents to form a first unitary metal disc that extends through the first portion of the metal layer; and/or providing one or more second metal disc constituents; and heating the one or more second metal disc constituents to form a second unitary metal disc that extends through the second portion of the metal layer.

### BRIEF DESCRIPTION OF THE DRAWINGS

Embodiments of the invention will now be described with reference to the accompanying drawings, in which:

FIG. 1 shows a wind turbine;

FIG. 2 shows a wind turbine blade;

FIG. 3 shows a planform view of a lightning protection system of the wind turbine blade including a metal layer in a blade shell of the blade;

FIG. 4 shows a chordwise section of a blade shell of the wind turbine blade;

FIG. 5 shows an overlapping region between portions of the metal layer;

FIG. 6 shows the metal layer connected to the lightning protection system via an electrical component;

FIG. 7 shows the electrically conductive pin extending through the outer layers of the blade;

FIG. 8A shows a pair of metal disc portions laid either side of the surface protection layer;

FIG. 8B shows a metal disc extending through the surface protection layer;

FIG. 8C shows a hole formed through the surface protection layer;

FIG. 8D shows an electrically conductive pin extending through the hole;

FIG. 8E shows the electrically conductive pin connected to the lightning protection system;

FIG. 9 shows a planform view of part of the lightning protection system including multiple discrete metal layer portions;

FIG. 10 shows a planform view of an alternative arrangement of the multiple discrete metal layer portions;

FIG. 11 shows a discontinuity between first and second portions of the metal layer forming an overlapping region between the locations of first and second electrically conductive pins;

FIG. 12A shows a blade mould;

FIG. 12B shows a first portion of a metal layer laid in the blade mould;

FIG. 12C shows a second portion of a metal layer laid in the blade mould;

FIG. 12D shows a third portion of a metal layer laid in the blade mould;

FIG. 12E shows a fibre layers laid on the blade mould;

FIG. 12F shows the blade mould covered by a vacuum bag;

FIG. 12G shows a portion of the blade removed from the blade mould;

FIG. 13 shows an electrically conductive pin extending through a surface protection layer comprising two metal layers;

FIG. 14 shows a schematic view of a lightning protection system comprising two metal layers and each comprising multiple discrete portions.

### DETAILED DESCRIPTION OF EMBODIMENT(S)

In this specification, terms such as leading edge, trailing edge, pressure surface, suction surface, thickness, chord and planform are used. While these terms are well known and understood to a person skilled in the art, definitions are given below for the avoidance of doubt.

The term leading edge is used to refer to an edge of the blade which will be at the front of the blade as the blade rotates in the normal rotation direction of the wind turbine rotor.

The term trailing edge is used to refer to an edge of a wind turbine blade which will be at the back of the blade as the blade rotates in the normal rotation direction of the wind turbine rotor.

The chord of a blade is the straight line distance from the leading edge to the trailing edge in a given cross section perpendicular to the blade spanwise direction. The term chordwise is used to refer to a direction from the leading edge to the trailing edge, or vice versa.

A pressure surface (or windward surface) of a wind turbine blade is a surface between the leading edge and the trailing edge, which, when the blade is in use, has a higher pressure than a suction surface of the blade.

A suction surface (or leeward surface) of a wind turbine blade is a surface between the leading edge and the trailing edge, which will have a lower pressure acting upon it than that of a pressure surface, when the blade is in use.

The thickness of a wind turbine blade is measured perpendicularly to the chord of the blade and is the greatest distance between the pressure surface and the suction surface in a given cross section perpendicular to the blade spanwise direction.

The term spanwise is used to refer to a direction from a root end of a wind turbine blade to a tip end of the blade, or vice versa. When a wind turbine blade is mounted on a wind turbine hub, the spanwise and radial directions will be substantially the same.

A view which is perpendicular to both of the spanwise and chordwise directions is known as a planform view. This view looks along the thickness dimension of the blade.

The term spar cap is used to refer to a longitudinal, generally spanwise extending, reinforcing member of the blade. The spar cap may be embedded in the blade shell, or may be attached to the blade shell. The spar caps of the windward and leeward sides of the blade may be joined by one or more shear webs extending through the interior hollow space of the blade. The blade may have more than one spar cap on each of the windward and leeward sides of the blade. The spar cap may form part of a longitudinal reinforcing spar or support member of the blade. In particular, the first and second spar caps may form part of the load bearing structure extending in the longitudinal direction that carries the flap-wise bending loads of the blade.

The term shear web is used to refer to a longitudinal, generally spanwise extending, reinforcing member of the blade that can transfer load from one of the windward and leeward sides of the blade to the other of the windward and leeward sides of the blade.

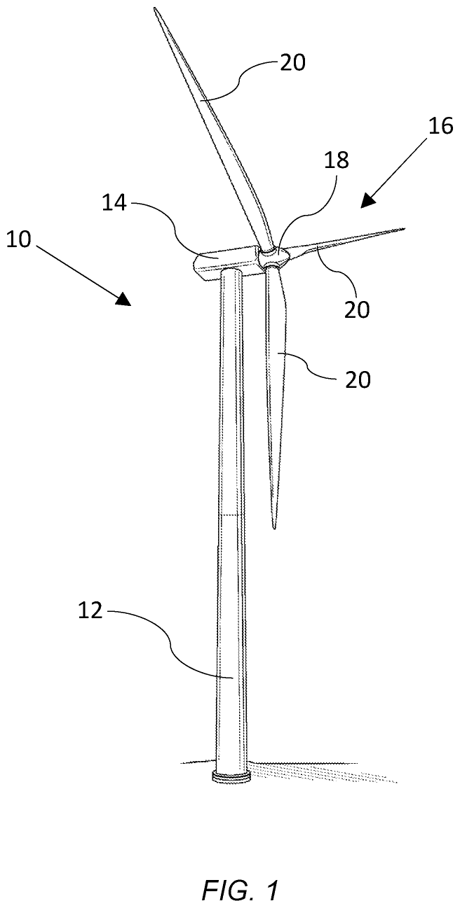

FIG. 1 shows a wind turbine 10 including a tower 12 mounted on a foundation and a nacelle 14 disposed at the apex of the tower 12. The wind turbine 10 depicted here is an onshore wind turbine such that the foundation is embedded in the ground, but the wind turbine 10 may be an offshore installation in which case the foundation would be provided by a suitable marine platform.

A rotor 16 is operatively coupled to a generator (potentially via a gearbox) (not shown) housed inside the nacelle 14. The rotor 16 includes a central hub 18 and a plurality of rotor blades 20, which project outwardly from the central hub 18. It will be noted that the wind turbine 10 is the common type of horizontal axis wind turbine (HAWT) such that the rotor 16 is mounted at the nacelle 12 to rotate about a substantially horizontal axis defined at the centre at the hub 18. While the example shown in FIG. 1 has three blades, it will be realised by the skilled person that other numbers of blades are possible.

When wind blows against the wind turbine 10, the blades 20 generate a lift force which causes the rotor 16 to rotate, which in turn causes the generator within the nacelle 14 to generate electrical energy.

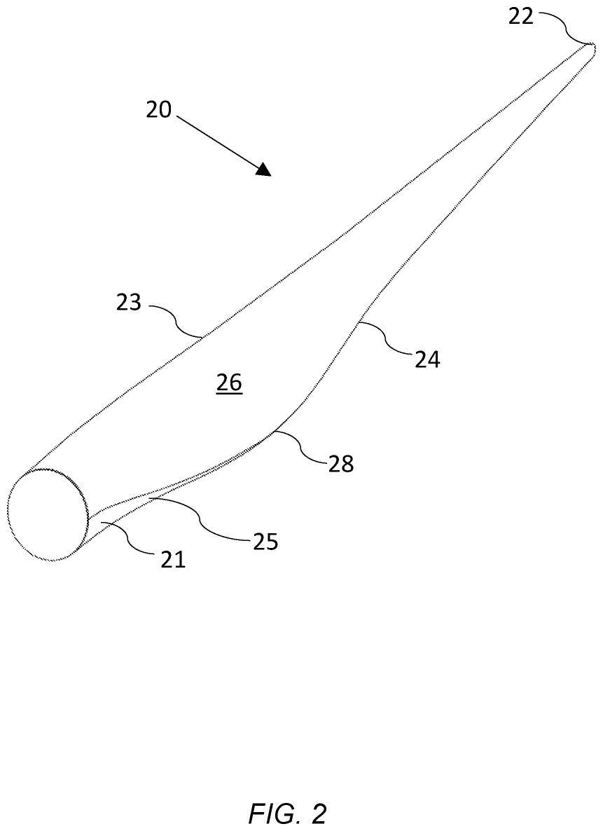

FIG. 2 shows an example of one of the wind turbine blades 20 for use in such a wind turbine. The blade 20 has a root end 21 proximal to the hub 18 and a tip end 22 distal from the hub 18. The blade 20 includes a leading edge 23 and a trailing edge 24 that extend between the root end 21 and tip end 22. The blade 20 includes a suction surface 25 and a pressure surface 26. A thickness dimension of the blade extends between the suction surface 25 and the pressure surface 26.

The blade 20 has a cross section that may be substantially circular near the root end 21. The blade portion near the root must have sufficient structural strength to support the blade portion outboard of that section and to transfer loads into the hub 18. The blade 20 may transition from a circular profile to an aerofoil profile moving from the root end 21 of the blade towards a “shoulder” 28 of the blade, which is the widest part of the blade 20 where the blade 20 has its maximum chord. The blade 20 has an aerofoil profile of progressively decreasing thickness in an outboard portion of the blade, which extends from the shoulder 28 to the tip end 22.

The wind turbine blade 20 may include an outer blade shell defining a hollow interior space with a shear web extending internally between upper and lower parts of the blade shell.

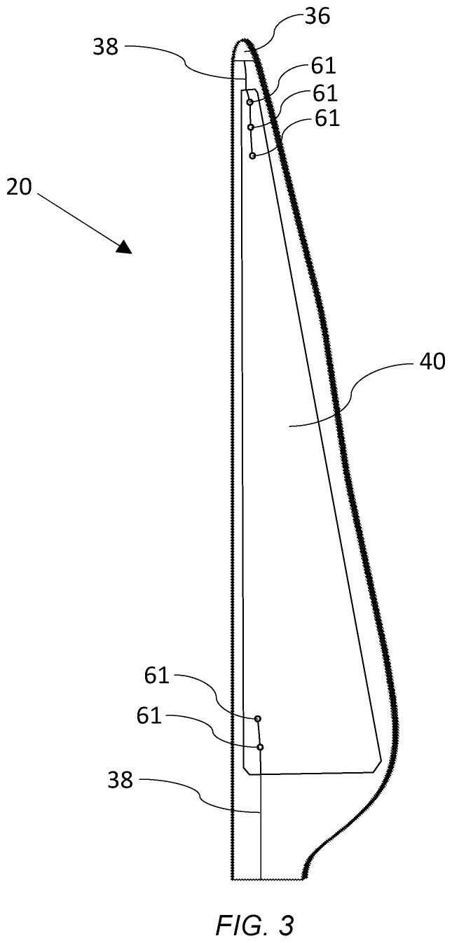

As shown schematically in FIG. 3, the blade 20 may include one or more lightning receptors 36 and one or more lightning down conductor cables 38 which form part of a lightning protection system for the wind turbine. The lightning receptors attract the lightning strike and the down conductor cables 38, which run through the hollow interior of the blade, conduct the energy of the lightning strike down the blade 20 via the nacelle 14 and tower 12 to a ground potential. In addition, the lightning protection system may include a surface protection layer 40 at the outer surface of the blade. The surface protection layer 40 may be electrically connected at each end to the down conductor cables 38.

The majority of the outer surface of the blade 20 may be covered with the surface protection layer 40, or only a portion of the outer surface of the blade 20 may be covered with the surface protection layer 40. The surface protection layer 40 serves to shield conductive material in the blade from a lightning strike, and may act as either a lightning receptor, a down conductor, or both. The down conductor may extend substantially the full length of the blade. In some examples, such as where the majority of the outer surface of the blade 20 is covered with the surface protection layer 40, the down conductor cable 38 may connect to the surface protection layer 40 adjacent the tip end 22 of the blade and adjacent the root end 21 of the blade, with no down conductor cable 38 along the majority of the length of the blade covered with the surface protection layer 40. The surface protection layer 40 may extend from root to tip in which case there may be no need for a down conductor cable 38. The surface protection layer 40 may extend in sections along the length of the blade with down conductor cable sections between the surface protection layer 40 sections. The down conductor cable 38 may alternatively extend under the surface protection layer 40 (inside the blade) so that the down conductor cable 38 and surface protection layer 40 are electrically connected in parallel.

At the root end 21 of the blade 20, the down conductor cable 38 may be electrically connected via an armature arrangement to a charge transfer route via the nacelle 14 or hub 18 and tower 12 to a ground potential. Such a lightning protection system therefore allows lightning to be channeled from the blade to a ground potential safely, thereby minimising the risk of damage to the wind turbine 10.

The down conductor cable 38 and surface protection layer 40 may be connected by one of more connectors or receptors. The connectors may comprise an electrically conductive pin 61 that extends through the surface protection layer 40 and connects to the down conductor cable 38. FIG. 3 shows five electrically conductive pins 61 connecting the down conductor cable 38 and the surface protection layer 40, although it will be understood that any suitable number of electrically conductive pin 61 may be used.

The surface protection layer 40 may extend up to the leading edge 23 of the wind turbine blade 20 and/or extend up to the trailing edge 24 of the wind turbine blade 20. Alternatively, the surface protection layer 40 may be spaced from the leading and/or trailing edge of the blade 20.

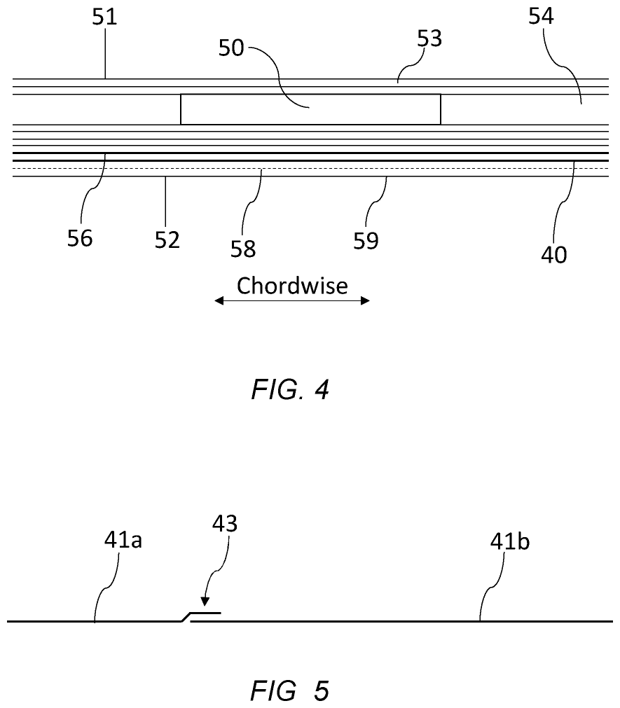

FIG. 4 shows a chordwise cross-section of the blade shell adjacent a suction surface of the wind turbine blade 20, viewed along a spanwise direction of the blade 20, although it will be clear that the features of the blade shell adjacent the pressure surface of the wind turbine blade 20 may be substantially the same.

The blade 20 includes a spar cap 50 where the shear web (not shown) meets the blade shell. The spar cap 50 is incorporated into the blade shell. In alternative arrangements the spar cap 50 may be connected to the inside of the blade shell. The spar cap 50 is an elongate reinforcing structure extending substantially along the full length of the blade 20 from the root end 21 to the tip end 22.

A core 54, such as a foam, balsa, or honeycomb core, may be positioned either side of the spar cap 50. One or more fibre layers 53 may be provided on an inner side of the spar cap 50, for example glass fibre layers or carbon fibre layers, which form the inner surface 51 of the blade 20. The fibre layers may be infused with resin to form a composite or may be pre-preg composite layers. Similarly, one or more layers 56 may be provided on an outer side of the spar cap 50. Where the spar cap is connected to the inside of the blade shell, the core 54 may fill between the one or more fibre layers 51 and one or more fibre layers 53.

The spar cap 50 may include conductive material, such as carbon fibres. For example, the spar cap 50 may include pultruded fibrous strips of material such as pultruded carbon fibre composite material or other carbon fibre reinforced plastic material.

The spar cap 50 may be equipotentially bonded to the surface protection layer 40 to ensure that there is no build-up of charge in the spar cap, or a large voltage difference between the surface protection layer 40 and the spar cap 50 in the event of a lightning strike. The equipotential bonding also prevents arcing between the surface protection layer 40 and the spar cap 50 which may damage the blade. As shown in FIG. 4, the surface protection layer 40 may have a chordwise extent in the chordwise direction of the blade 20 which is wider than the width of the spar cap 50. This helps to ensure the spar cap 50 is well protected from lightning strike by the surface protection layer 40.

As previously discussed, the surface protection layer 40 is an electrically conductive layer located at an outer surface 52 of the blade 20, however it will be seen from FIG. 4 that the blade 20 may include one or more of: a fleece layer 58, and a gelcoat and/or paint layer 59. For example, a fleece layer 58 and a gelcoat layer 59 may be located between the surface protection layer 40 and the outer surface 52 of the blade 20.

The surface protection layer 40 includes a metal layer 41. The metal layer 41 is split into at least a number of portions 41a, 41b with a discontinuity between each of the portions 41a, 41b. FIG. 5 shows an example of a discontinuity between a first portion 41a and a second portion 41b. Typically, the first portion 41a and the second portion 41b of the metal layer 41 overlap partially so as to form an overlap region 43. The discontinuity between the portions 41a, 41b of the metal layer 41 may enable the metal layer portions 41a, 41b to be laid up sequentially in a blade mould and/or moved relative to one another within the mould prior as they are incorporated into the blade shell.

The overlapping regions 43 (alternatively referred to as overlapping edges) may assist in providing the required electrical connection across the metal layer 41, however the size of these overlapping regions 43 is typically minimised. For instance, the overlapping region 43 may have an overlap width of less than 200 mm, and typically less than 100 mm.

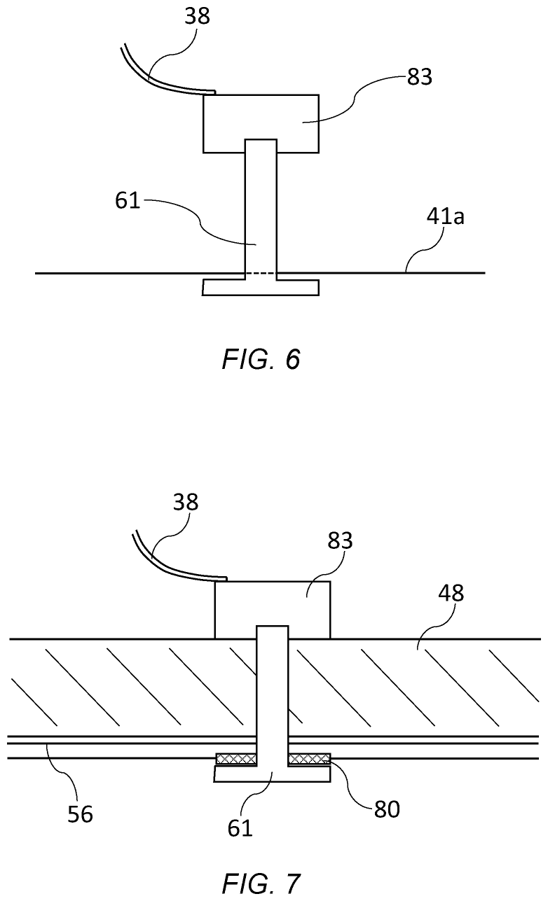

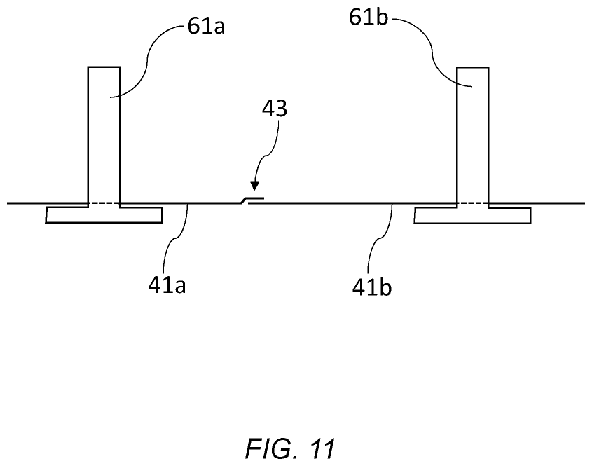

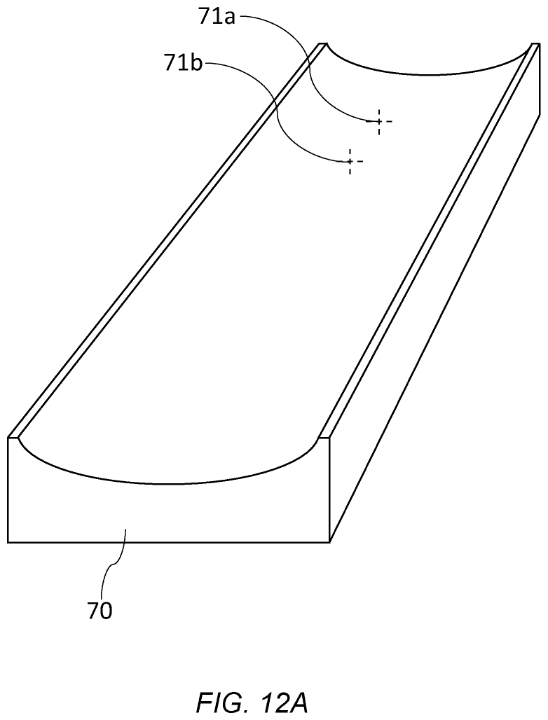

Each portion 41a, 41b of the metal layer 41 may be connected to the lightning protection system by a respective electrical component. FIG. 6 shows an example in which an electrically conductive pin 61 extends through the first metal layer portion 41a to a receptor block 83. As will be apparent from the examples shown below, the second metal layer portion 41b, which is separated from the first metal layer portion 41a by a discontinuity, may be arranged similarly. In particular, the electrically conductive pin 61 of the first metal layer portion 41a may extend through the first metal layer portion 41a and not through the second metal layer portion 41b and the electrically conductive pin of the second metal layer portion 41b may extend through the second metal layer portion 41b and not through the first metal layer portion 41a (as described in further detail in relation to FIG. 11). The receptor block 83 connected to an electrically conductive pin 61 is electrically conductive and may be connected to a down conductor cable 38 that extends through the blade 20. In this way, the metal layer 41 may form part of the lightning protection system of the wind turbine blade 20.

As shown in FIG. 7, in extending through the first portion of the metal layer 41a to the receptor block 83, the electrically conductive pin 61 may extend through number of other components, such as a metal disc 80, one or more fibre layers 56, and a further structural component 48 (e.g. including additional fibre layers, core materials such as foam, and similar, as will be appreciated by the person skilled in the art). The receptor block 83 may be bonded to the inner surface of the blade 20, for example the receptor block 83 may be bonded to the structural component 48.

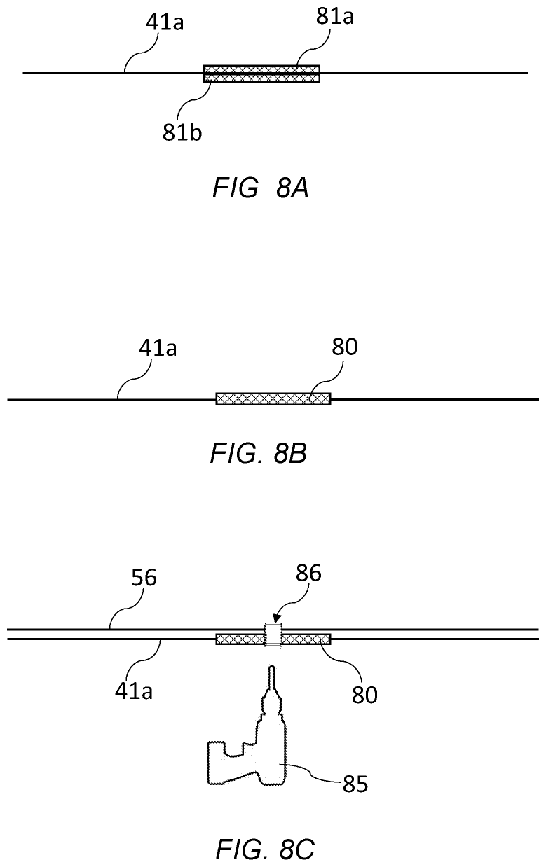

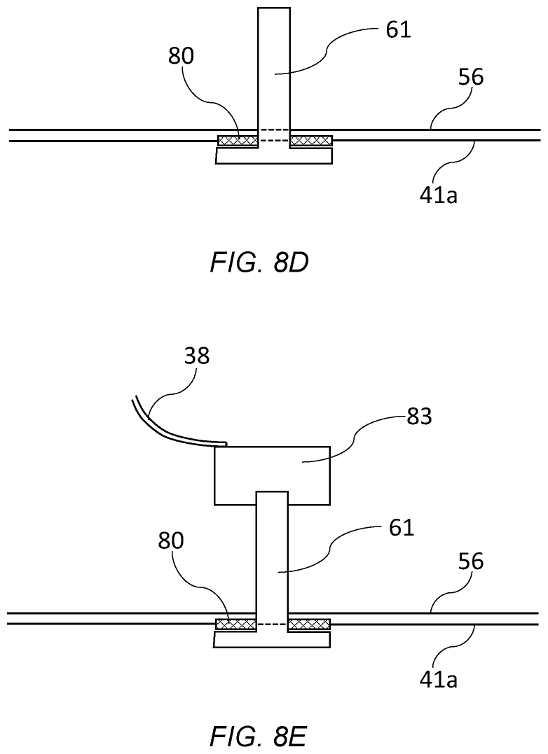

In order to promote a good electrical contact between the first portion 41a (or any other portion) of the metal layer 41 and its respective connector (particularly the electrically conductive pin 61), the metal layer 41 may include reinforced zones. FIGS. 8A-8E show an example of the formation of a reinforced zone, in which the connector comprises a disc 80 extending through the metal layer 41, although it will be appreciated that the reinforced zone may comprise any suitably conductive element.

The metal disc 80 may be formed from one or more metal disc constituents. The metal disc constituents may be a pair of metal disc portions 81a, 81b, for example as shown in FIG. 8A. The metal disc portions 81a, 81b may be laid on either side of the first portion 41a of the metal layer 41, such that the metal layer 41 is sandwiched between the first and second metal disc portions 81a, 81b.

The metal disc portions 81a, 81b may subsequently be consolidated to form a single (unitary) metal disc 80 that extends through the first portion of the metal layer 41. FIG. 8B shows an example of a metal disc 80 extending across the metal layer 41.

In some examples, the metal disc 80 may be formed by heating the first and second metal disc portions 81a, 81b together. Alternatively, the metal disc 80 (such as shown in FIG. 8B) may be cast from molten metal to form a metal disc 80 that extends through the metal layer 41.

One or more fibre layers 56 may be laid on the metal disc 80, as shown in FIG. 8C. A drill 85 or other device may form a hole 86 through the metal disc 80 and fibre layers 56 so as to provide a through-hole for inserting the electrically conductive pin 61, as shown in FIG. 8D. By forming the through hole, the disc 80 becomes an annulus.

The electrically conductive pin 61 may extend through the hole 86 so as to electrically connect the metal layer 41a to the rest of the lightning protection system. For example, FIG. 8E shows an electrically conductive pin 61 extending through the metal disc 80 to a receptor block 83, and in doing so extending through a first portion 41a of the metal layer 41 and a plurality of fibre layers 56. The electrically conductive pin 61 may also extend through further structural components, as previously discussed.

As shown in FIG. 3, the lightning protection system may include multiple electrically conductive pins 61 that are adjacent to one another. In this context, adjacent may mean the first and second electrically conductive pins 61 are within 5%, 4%, 3%, 2% or 1% of the total blade length from one another.

The handleability of the metal layer 41 may decrease when the first metal layer 41 includes more than one discrete reinforced zone, for example when the metal layer 41 is designed such that more than one electrically conductive pin 61 extends through the metal layer 41. Including two discrete reinforced zones may increase the likelihood of warping or shear of the metal layer 41 occurring, and thereby make manufacturing/assembly more difficult.

In addition, the metal layer 41 is typically provided by the manufacturer as a flat sheet, or roll of material to deliver a flat sheet, whereas the blade 20 typically includes at some geometrical portions having a three-dimensional shape. Accordingly, at least some of the metal layer 41 may therefore become unavoidably warped or stretched as a consequence of conforming to this complex curvature in a blade mould (e.g. the metal layer 41 may contain areas of increased or decreased density associated with the three-dimensional shape). The problem of warping and/or stretching may undesirably increase if a metal layer 41 needs to be aligned with more than one toleranced blade position, e.g. at more than one conductive pin position, when conforming the sheet to a three dimensional shape. Providing multiple, smaller, discrete metal layer portions ameliorates this problem.

The benefits of providing a metal layer 41 formed of two or more portions may additionally include robustness against process errors and/or manufacturing errors, as only a discrete portion of the metal layer 41 needs to be repaired or replaced, rather than a larger metal layer portion or even the entire metal layer 41.

Multiple, smaller, discrete metal layer portions may also allow one or more similarly dimensioned metal layer portions to be used in multiple blades designs (e.g. of different blade length, or different blade tip geometry. for example) to provide a modular blade design among a family of blades.

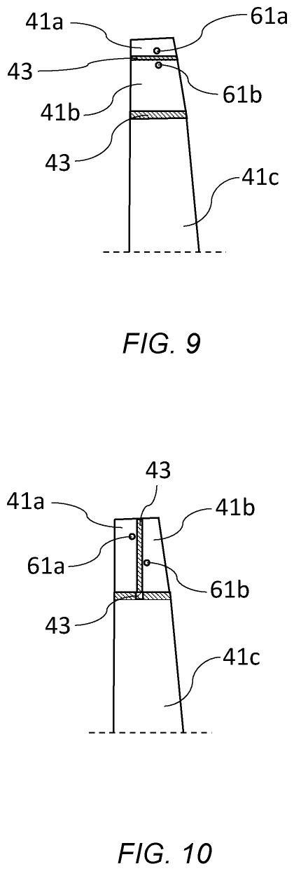

Accordingly, the metal layer 41 may be cut/sized so that only a single electrically conductive pin 61 location coincides with a particular discrete portion of the metal later 41, i.e. only a single electrically conductive pin 61 extends through each portion 41a, 41b of the metal layer 41. An example of such an arrangement is shown in FIG. 9.

FIG. 9 shows a schematic view of part of a lightning protection system including multiple discrete portions 41a, 41b, 41c of the metal layer 41, and in which a first electrically conductive pin 61a extends through one of the metal layer portions 41a but not through any of the other metal layer portions 41b, 41c. Similarly, a second electrically conductive pin 61b extends through one of the metal layer portions 41b but not through any of the other metal layer portions 41a, 41c. This helps to improve the handleability of the metal layer portions 41a, 41b, 41c, as the metal layer portions 41a, 41b, 41c may each include a maximum of one discrete reinforced zone.

The handleability of a metal layer portion 41a, 41b, 41c may also be improved by minimising the size of a metal layer portion 41a, 41b, 41c, particularly when that metal layer portion 41a, 41b includes a reinforced zone. For example, FIG. 9 shows an example in which the first and second portions 41a, 41b are separate from a third portion 41c, even though the third portion 41c may not include a reinforced zone. The size of the first and/or second portions 41a, 41b may be selected such that the surface area of that portion 41a, 41b is less than a maximum size, for example each metal layer may have a surface area of less than 20% of a total surface area of the wind turbine blade, or less than 10%.

Whilst FIG. 9 shows the metal layer 41 split in a spanwise direction such that the discontinuity between each of the first, second and third metal layer portions 41a, 41b, 41c extends in a substantially chordwise direction, it will be understood that the discontinuity may extend in any direction within the plane of the metal layer.

FIG. 10 shows an example in which the metal layer 41 is split in multiple directions. The discontinuity between the first and second metal layer portions 41a, 41b extends in a generally spanwise direction of the blade 20, whilst the discontinuity between the third metal layer portion 41c and each of the first and second metal layer portions 41a, 41b extends in a generally chordwise direction of the blade 20.

Each of the portions 41a, 41b, 41c may meet at an overlap region 43 in which one of the portions 41a, 41b, 41c extends over and overlaps one of the other adjacent portions 41a, 41b, 41c. FIG. 11 shows an example in which the first portion 41a overlaps a section of the second portion 41b at an overlapping region. The overlapping region 43 may assist in improving the electrical connection across the metal layer 41. Although any other suitable arrangement to improve the electrical connection between the portions 41a, 41b of the metal layer 41 may be utilised, such as a third portion of the metal layer 41 extending over each of the first and second portions 41a, 41b of the metal layer 41.

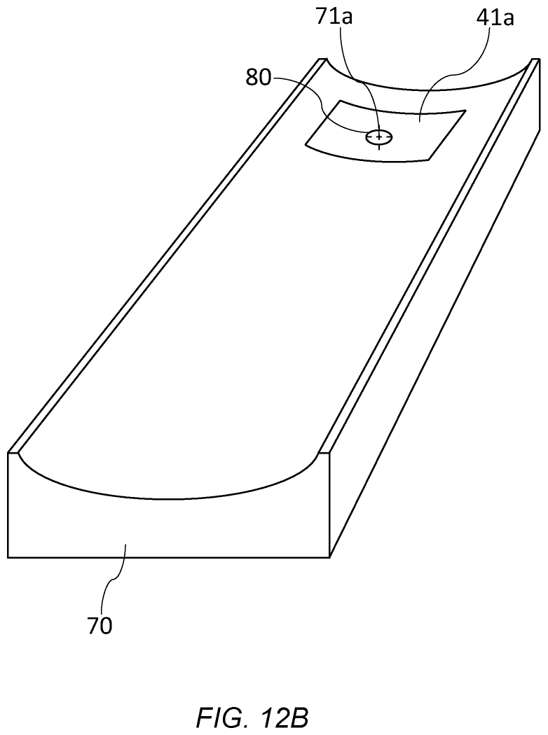

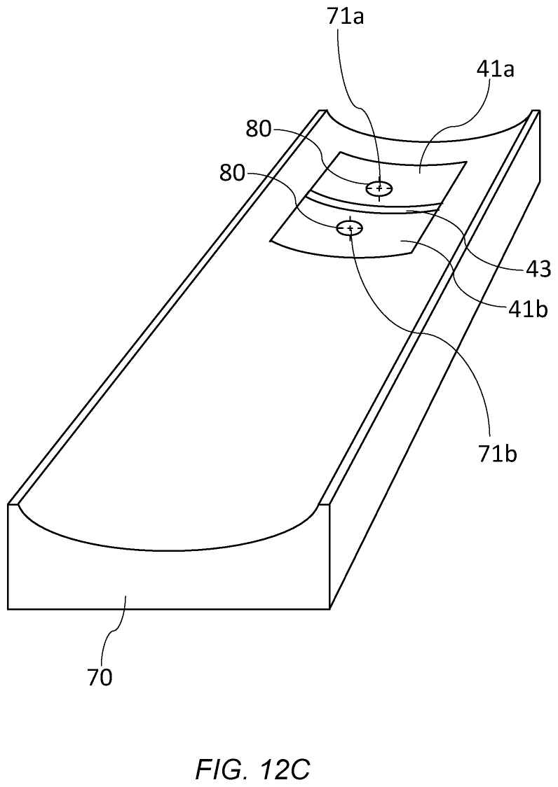

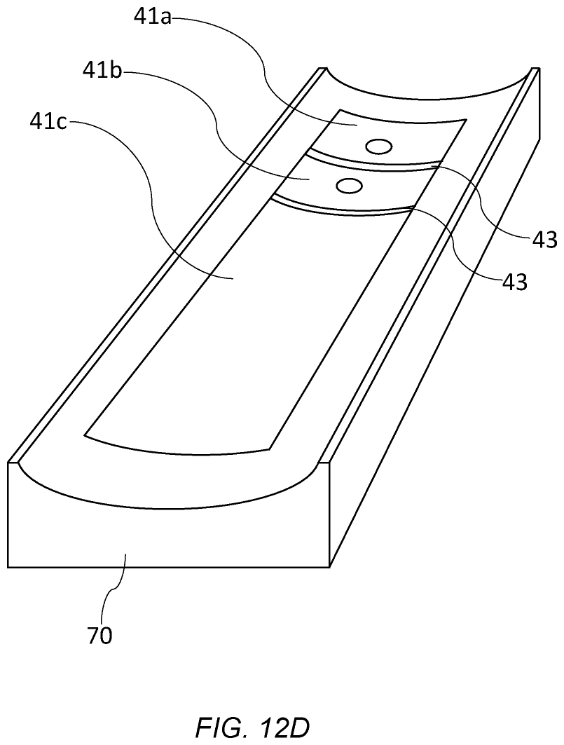

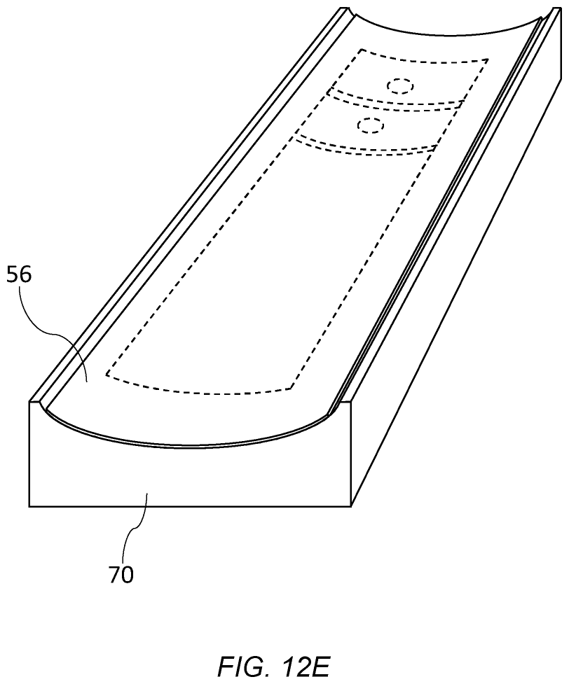

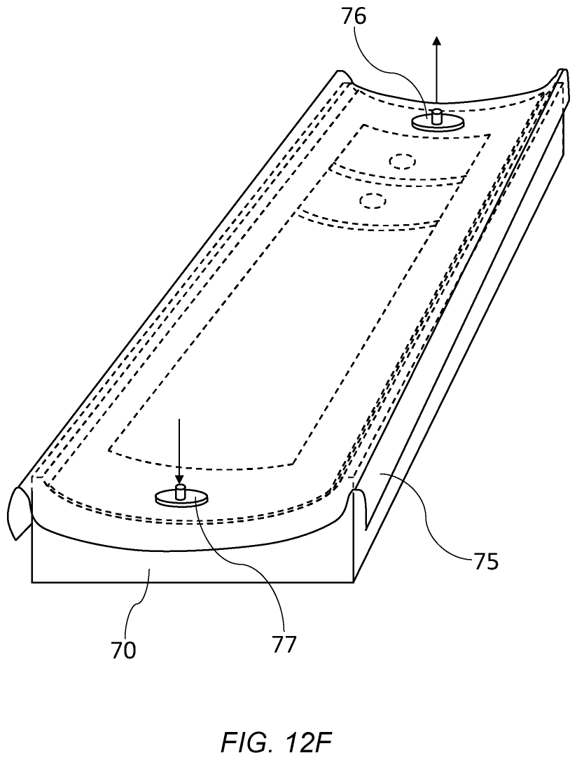

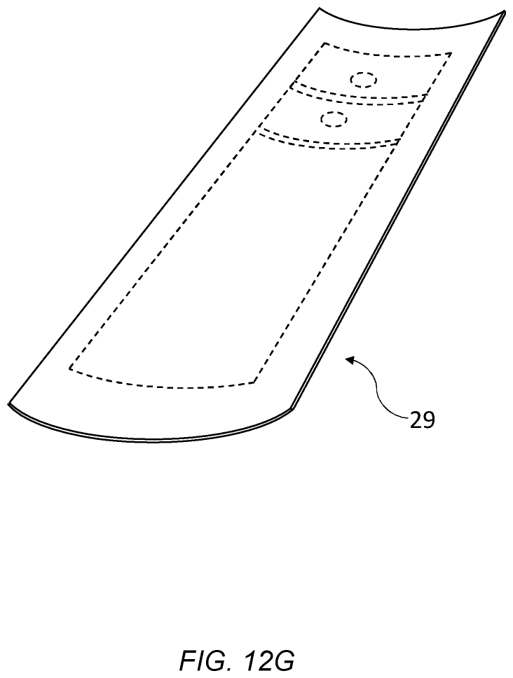

A method of manufacturing a wind turbine blade including at least two electrically conductive pins 61 will now be described in relation to FIGS. 12A-12G.

FIG. 12A shows an example indicating the respective blade positions 71a, 71b of the electrically conductive pins 61 of the blade 20 that are determined on a blade mould 70. In this example the blade 20 (or segment 29 thereof) formed in the blade mould 70 includes two electrically conductive pins 61a, 61b, a first electrically conductive pin 61a positioned at a first blade position 71a and a second electrically conductive pin 61b at a second blade position 71b.

A first portion 41a of the metal layer 41 is laid in the blade mould 70 so as to overlay the determined blade position 71a of the first electrically conductive pin 61a and not overlay the determined blade position 71b of the second electrically conductive pin 61b, for example as shown in FIG. 12B.

It should be understood that various layers may be laid onto the blade mould 70 prior to the first portion 41a of the metal layer 41 (and/or the second portion 41b of the metal layer 41) so as to form the outer surface 52 of the blade 20, for example one or more of: a fleece layer 58, a gelcoat and a paint layer 59.

Positioning the first portion 41a of the metal layer 41 in the blade mould 70 may involve aligning the first portion 41a of the metal layer 41 with the determined blade position 71a of the first electrically conductive pin 61a, for example the first portion 41a of the metal layer 41 may comprise a pin locating feature (e.g. a datum) that is aligned with the determined blade position 71a to ensure accurate positioning of the first portion 41a. The pin locating feature may be the metal disc 80 and/or the centre of the metal disc 80.

A second portion 41b of the metal layer 41 is laid in the blade mould 70 so as to overlay the determined blade position 71b of the second electrically conductive pin 61b and not overlay the determined blade position 71a of the first electrically conductive pin 61, for example as shown in FIG. 12C. The second portion 41b of the metal layer 41 may be laid in the blade mould 70 so that an edge of the second portion 41b overlaps an edge of the first portion 41a, thereby forming an overlapping region 43. The overlapping region 43 may assist in providing the required electrical connection across the metal layer 41 between the first portion 41a and the second portion 41b.

Positioning the second portion 41b of the metal layer 41 in the blade mould 70 may involve aligning the second portion 41b of the metal layer 41 with the determined blade position 71b of the second electrically conductive pin 61b, for example as described in regard to the first portion 41a.

Further portions 41c of the metal layer 41 may be laid in the blade mould 70. FIG. 12D shows an example in which a third portion 41c of the metal layer 41 is laid into the blade mould 70. In this case, the third portion 41c does not overlay the determined blade positions 71a, 71b of any electrically conductive pins 61, and specifically the first and second electrically conductive pins 61a, 61b shown in this example. However, it will be understood that in alternative examples the third portion 41c (or subsequent portions) of the metal layer 41 may overlay the determined blade position of a further electrically conductive pin 61.

One or more fibre layers 56 (e.g. dry fibre preforms or pre-preg composite layers) may be laid on the blade mould 70, on top of the portions 41a, 41b, 41c of the metal layer 41, for example as shown in FIG. 12E.

The blade 20 in the blade mould 70 may subsequently be prepared. This may involve consolidating the fibre layers 56 and metal layer 41, e.g. covering the blade mould 70, including the fibre layers 56 and metal layer 41, in a vacuum bag 75 and applying a vacuum pressure through a first valve 76. The fibre layers 56 may subsequently be cured, e.g. under heat and/or pressure. In some examples, the fibre layers 56 may be dry fibre preforms, or similar, requiring the addition of resin to the blade mould 70. In the example shown in FIG. 12F, a second valve 77 is provided for the infusion of resin. In either case, the resin will integrate both the fibre layers 56 and the metal layer 41 so as to form a unitary segment 29 of the blade 20.

The cured segment 29 of the blade 20 will subsequently be removed from the mould, for example as shown in FIG. 12G. The first electrically conductive pin 61a may be extended through the first portion 41a of the metal layer 41 and coupled to the lightning protection system, for example via a down conductor cable 38. Similarly, the second electrically conductive pin 61b may be extended through the second portion 41b of the metal layer 41 and coupled to the lightning protection system.

In the above example, the surface protection layer 40 includes a single metal layer 41, with any overlapping regions 43 between adjacent portions 41a, 41b, 41c of the metal layer having an overlap width of less than 200 mm, and typically less than 100 mm. However, it will be understood at least a portion of the surface protection layer 40 may be formed of multiple electrically conductive metal layers 41, 42 stacked upon one another in the thickness direction of the blade 20. In this case, the metal layers 41, 42 form a multiple-thickness region, which may be distinguished from an overlapping region 43 between portions 41a, 41b, 41c of a metal layer 41 in that the multiple-thickness region has a width of at least 200 mm and a length of at least 200 mm.

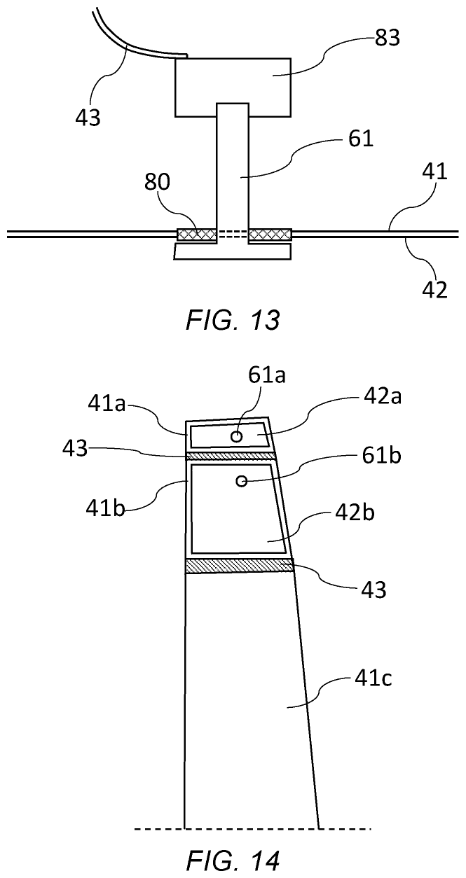

FIG. 13 shows a surface protection layer 40 comprising a first metal layer 41 and a second metal layer 42. The first and second metal layers 41, 42 are positioned at an outer surface of the blade shell and stacked on each other so as to form a multiple-thickness region of the surface protection layer 40 where intimate electrical contact between the first metal layer 41 and second metal layer 42 is formed.

An electrically conductive pin 61 may extend through both the first and second metal layers 41, 42. In addition, the electrically conductive pin 61 may extend through a disc 80 formed across the metal layers 41, 42. The disc may be formed substantially as described in relation to FIGS. 8A-8E, with the metal disc portions 81a, 81b consolidated to form a single (unitary) metal disc 80 that extends through both the first and second metal layers 41, 42, such that the first and second metal layers 41, 42 are connected.

The blade 20 may otherwise be formed substantially as described in relation to FIGS. 12A-12G, with the resin integrating the fibre layers 56 and metal layers 41, 42 so as to form a unitary segment 29 of the blade 20.

It will be appreciated that the handleability of larger sized multiple pre-attached metal layers 41, 42 may be decreased compared to a single metal layer 41, as one or both layers 41, 42 may warp or shear or otherwise move out of alignment with the other metal layer 41, 42, and this can make manufacturing more difficult. This may provide further incentive to cut/size the metal layers 41, 42 so that only a single electrically conductive pin 61 location coincides with a particular discrete portion of the surface protection layer 40 being laid in the blade mould 70.

FIG. 14 shows a schematic view of part of a lightning protection system including multiple discrete portions 41a, 41b, 41c of a first metal layer 41, and multiple discrete portions 42a, 42b of a second metal layer 42 (such that there is a discontinuity between the portions of each metal layer 41, 42). In this arrangement, the first portion 42a of the second metal layer 42 is stacked on the first portion 41a of the first metal layer 41 to form intimate electrical contact with the first portion 41a of the first metal layer 41. Similarly, the second portion 42b of the second metal layer 42 is stacked on the second portion 41b of the first metal layer 41 to form intimate electrical contact with the second portion 41b of the first metal layer 41.

In this example, a first electrically conductive pin 61a extends through the first portions 41a, 42a of the first and second metal layers 41, 42 but not through any of the other metal layer portions 41b, 41c, 42b. Similarly, a second electrically conductive pin 61b extends through the second portions 41b, 42b of the first and second metal layers 41, 42 but not through any of the other metal layer portions 41a, 41c, 42a. This improves the handleability of the metal layer portions 41a, 41b, 41c, 42a, 42b as they may each include a maximum of one discrete reinforced zone.

It should be noted that whilst FIG. 14 shows the portions 42a, 42b of the second metal layer 42 spaced from the perimeter of the respective portions 41a, 41b of the first metal layer 41, it will be understood that this is merely illustrative and that the portions 42a, 42b of the second metal layer 42 may also extend up to the perimeter of the portions 41a, 41b of the first metal layer 41 or extend beyond the perimeter of the portions 41a, 41b of the first metal layer 41 at various points.

It will be appreciated that the first metal layer 41 and the second metal layer 42 may be formed of any suitably electrically conductive metal, for example aluminium, copper, stainless steel, brass, or bronze. The first and/or second metal layers 41, 42 may be a metallic foil. A metallic foil may provide benefits in terms of being lightweight whilst being highly electrically conductive. Further weight savings may be achieved by forming the first and/or second metal layers 41, 42 as a metal mesh, solid foil, or an expanded metal foil. The first and/or second metal layers 41, 42 may be any suitably thin sheet-like conducting material. The sheet material for forming the first and/or second metal layers 41, 42 may have a thickness of less than 1 mm, optionally between 0.2 mm and 0.6 mm, and optionally between 0.25 mm and 0.5 mm or between 0.2 mm and 0.3 mm. The first and second metal layers 41, 42 may have the same thickness or a different thickness.

The first and second metal layers 41, 42 may be formed of the same material. For example, the first and second metal layers 41, 42 may both be aluminium layers. Alternatively, the first and second layers 41, 42 may be formed of different but complementary materials. For example, one of the layers 41, 42 may be formed of aluminium and the other layer 41, 42 may be formed of copper. Such a combination balances the light and inexpensive qualities of aluminium with the increased electrical conductivity of copper.

Similarly, the first and second portions of each metal layer 41, 42 may be formed of the same material, or may be formed of different materials. For example, a first portion 41a of the first metal layer 41 may be formed of aluminium, whilst a second portion of the second metal layer 41 is formed of copper. This allows the choice of material in each section of the blade 20 to be decided based on balancing various requirements of the blade 20 at each of the respective sections, e.g., weight, electrical conductivity, and cost.

Although the invention has been described above with reference to one or more preferred embodiments, it will be appreciated that various changes or modifications may be made without departing from the scope of the invention as defined in the appended claims.

1. A wind turbine blade having a blade shell with a lightning protection system;
the lightning protection system comprising:
a first electrically conductive pin, and a second electrically conductive pin adjacent to the first electrically conductive pin;
a metal layer at an outer surface of the blade shell, the metal layer split into a first portion and a second portion with a discontinuity between the first and second portions;
wherein the first electrically conductive pin extends through the first portion of the metal layer and not through the second portion of the metal layer; and wherein the second electrically conductive pin extends through the second portion of the metal layer and not through the first portion of the metal layer.

2. The wind turbine blade of claim 1, wherein the first portion and the second portion partially overlap to form an overlap region.

3. The wind turbine blade of claim 1, comprising an electrical component, wherein the first portion of the metal layer is electrically connected to the electrical component by the first electrically conductive pin and the second portion of the metal layer is electrically connected to the electrical component by the second electrically conductive pin.

4. The wind turbine blade of claim 1, wherein the electrical component is a down conductor of the lightning protection system.

5. The wind turbine blade of claim 1, wherein the first electrically conductive pin extends through a first unitary disc formed across the metal layer and/or the second electrically conductive pin extends through a second unitary disc formed across the metal layer.

6. The wind turbine blade of claim 1, wherein the metal layer is a first metal layer, and the lightning protection system further comprises a second metal layer at the outer surface of the blade shell, the second metal layer split into a first portion and a second portion with a discontinuity between the first and second portions,
wherein the first portion of the second metal layer is stacked on the first portion of the first metal layer to form intimate electrical contact with the first portion of the first metal layer, and wherein the first electrically conductive pin extends through the first portion of the first metal layer and the first portion of the second metal layer; and/or
wherein the second portion of the second metal layer is stacked on the second portion of the first metal layer to form intimate electrical contact with the second portion of the first metal layer, and wherein the second electrically conductive pin extends through the second portion of the first metal layer and the second portion of the second metal layer.

7. The wind turbine blade of claim 5, wherein the first unitary disc extends through the first portion of the first metal layer and the first portion of the second metal layer and/or wherein the second unitary disc extends through the second portion of the first metal layer and the second portion of the second metal layer.

8. The wind turbine blade of claim 1, wherein the first portion and the second portion of the first and/or second metal layer is formed of the same material and/or have the same thickness.

9. The wind turbine blade of claim 6, wherein the first metal layer and the second metal layer are formed of different materials, or wherein the first portion of the first or second metal layer is formed of a different material to the second portion of the first or second metal layer.

10. A method of manufacturing a wind turbine blade having a blade shell, comprising:
providing a blade mould, and a metal layer of a lightning protection system of the blade shell, wherein the metal layer is split into a first portion and a second portion;
determining a respective blade position of a first electrically conductive pin and a second electrically conductive pin;
laying a first portion of the metal layer in the blade mould so as to overlay the determined blade position of the first electrically conductive pin and not overlay the determined blade position of the second electrically conductive pin;
laying a second portion of the metal layer in the blade mould so as to overlay the determined blade position of the second electrically conductive pin and not overlay the determined blade position of the first electrically conductive pin.

11. The method of manufacturing a wind turbine blade of claim 10,
wherein the step of laying a first portion of the metal layer in the blade mould further comprises aligning a pin locating feature of the first portion of the metal layer with the determined blade position of the first electrically conductive pin; and/or
wherein the step of laying a second portion of the metal layer in the blade mould further comprises aligning a pin locating feature of the second portion of the metal layer with the determined blade position of the second electrically conductive pin.

12. The method of manufacturing a wind turbine blade of claim 10, wherein the step of laying a second portion of the metal layer in the blade mould further comprises overlapping an edge of the second portion with an edge of the first portion to form an overlap region.

13. The method of manufacturing a wind turbine blade of claim 10, further comprising:
extending a first electrically conductive pin through the first portion of the metal layer and coupling the first electrically conductive pin to a down conductor; and/or
extending a second electrically conductive pin through the second portion of the metal layer and coupling the second electrically conductive pin to a down conductor.

14. The method of manufacturing a wind turbine blade of claim 10, further comprising:
laying fibre layers of the blade shell in the blade mould;
consolidating the fibre layers and the metal layer in the blade mould and integrating the fibre layers and metal layer with a resin.

15. The method of manufacturing a wind turbine blade of claim 10, further comprising, prior to laying the metal layer in the blade mould:
providing one or more first metal disc constituents; and heating the one or more first metal disc constituents to form a first unitary metal disc that extends through the first portion of the metal layer; and/or
providing one or more second metal disc constituents; and heating the one or more second metal disc constituents to form a second unitary metal disc that extends through the second portion of the metal layer.
